(19) United States
(12) Patent Application Publication
(10) Pub. No.: US 2008/0284273 A1
(43) Pub. Date: Nov. 20, 2008

(54) Lead frame

(76) Inventor: Stephen H. Purvines, Mishawaka, IN (US)

Correspondence Address: BROOKS, CAMERON & HUEBSCH , PLLC, 1221 NICOLLET AVENUE , SUITE 500, MINNEAPOLIS, MN, 55403, US

(21) Appl. No.: 11/804,076

(22) Filed: May 17, 2007

(51) Int. Cl. H02K 1/12; H02K 15/02

(52) U.S. Cl. 310/258; 29/596

(57) ABSTRACT

Devices and methods are provided for a lead frame, stator, and electric motor. One embodiment for a lead frame includes two or more control tracks for connection to a stator winding. The lead frame also includes a Hall-effect sensor coupled to two or more signal tracks for sensing a magnetic field and for providing electric signals to a control circuit and a capacitor coupled to the two or more signal tracks for dampening the electric signal provided by the Hall-effect sensor. The lead frame can also include a removable support for maintaining a predetermined distance between the two or more control tracks and the two or more signal tracks.

### INTRODUCTION

Electrical motors and generators typically include a stator that is mounted inside a housing and a rotor that is supported for rotation relative to the stator. The rotor can include a shaft and a set of permanent magnets mounted to the shaft. The stator can include a motor casing and coils which can be wound in slots inside of the motor casing. The rotor shaft couples to the motor casing such that the rotor is capable of rotating relative to the casing, and such that the stator coils surround the set of permanent magnets mounted to the shaft. The stator can include a number of stator sections configured to form a ring-like cylinder. The ring-like cylinder of the stator receives the rotor in such a way as to allow the two structures to magnetically interact to create motion.

One aspect of creating this magnetic interaction is found in the stator sections. When a potential is applied through the stator coils an electromagnetic field can be generated. In addition to the electromagnetic field, heat can also be generated due to the electrical resistance of the conductive wire. The more efficiently this heat can be dissipated, the more efficiently the motor can run.

### BRIEF DESCRIPTION OF THE DRAWINGS

The Figures presented herein provide illustrations of non-limiting example embodiments of the present disclosure. The Figures are not necessarily to scale.

FIGS. 1A-1C illustrate an embodiment of a lead frame according to the present disclosure.

FIG. 2 illustrates an embodiment of a stator and a lead frame according to the present disclosure.

FIGS. 3A-3B illustrate an embodiment of an over-molded housing encasing a stator and a lead frame according to the present disclosure.

FIG. 4 illustrates an exploded view of an embodiment of an electric motor according to the present disclosure.

### DETAILED DESCRIPTION

Embodiments of the present disclosure include lead frames, stators, electric motors, and methods of making a stator coupled to the lead frame of the present disclosure. As used herein, lead frames include, but are not limited to, structures that connect an electric motor stator with a control circuit to control the motor commutation process and output currents to the stator in a way that controls the position of a rotor relative to the stator. It will be apparent to those skilled in the art that the following description of the various embodiments of this disclosure are provided for illustration only and not for the purpose of limiting the invention as defined by the appended claims and their equivalents.

As will be described herein, an electric motor includes, among other things, a rotor, a stator disposed around the rotor, and a lead frame coupled to the stator. In the embodiments described in the present disclosure, the stator and lead frame are encapsulated within a thermoset material. In some embodiments, electrically conductive tracks which are part of the lead frame and can form an electrical connection between the stator and a control circuit, extend from the thermoset material. As used herein, a thermoset material includes those polymeric materials that once shaped by heat and pressure so as to form a cross-linked polymeric matrix are incapable of being reprocessed by further application of heat and pressure.

Embodiments of the present disclosure include, but are not limited to, a lead frame for a stator that includes, among other things, two or more control tracks for connection to a stator winding, a Hall-effect sensor coupled to two or more signal tracks for sensing a magnetic field and for providing electric signals to a control circuit, a capacitor coupled to the two or more signal tracks for dampening the electric signal provided by the Hall effect sensor, and a removable support for maintaining a predetermined distance between the two or more control tracks and the two or more signal tracks.

Embodiments of the present disclosure can also include a stator including a stator winding and a lead frame connected to the stator winding, where the lead frame includes two or more electrically conductive tracks to carry electric signals for control of the stator, and an over-molded housing encasing the stator and the lead frame.

Embodiments of the present disclosure can further include an electric motor including a stator, a rotor that rotates relative the stator, a stator winding wound on the stator for generating a magnetic field for driving the rotor, a lead frame connected to the stator winding, and an over-molded housing encasing the stator and the lead frame, where the housing extends between the two or more electrically conductive tracks.

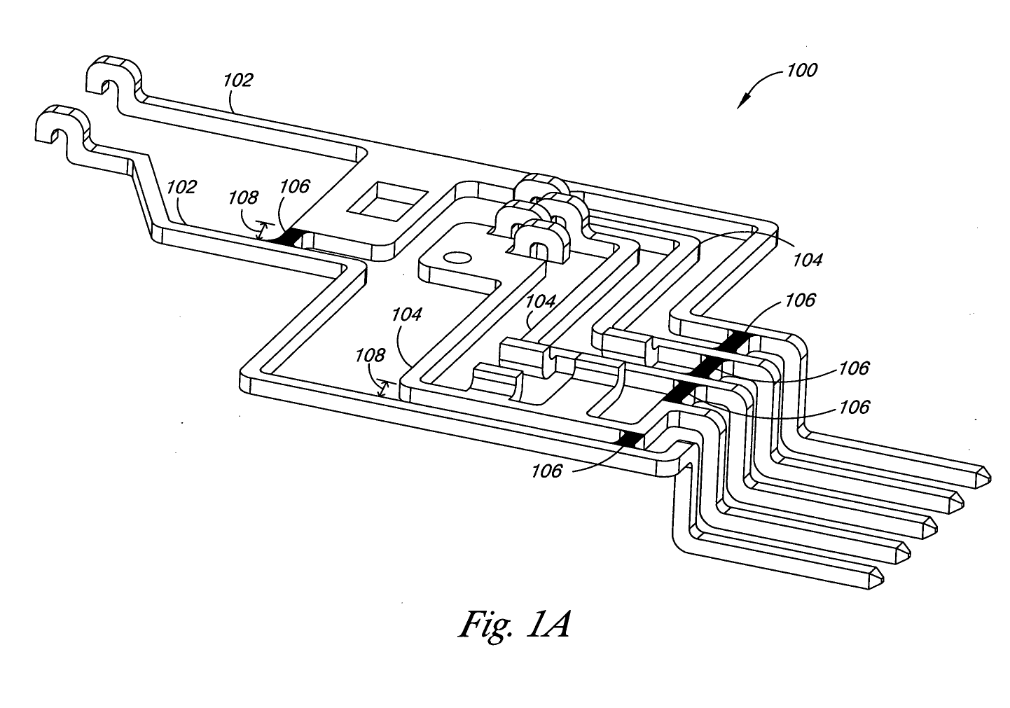

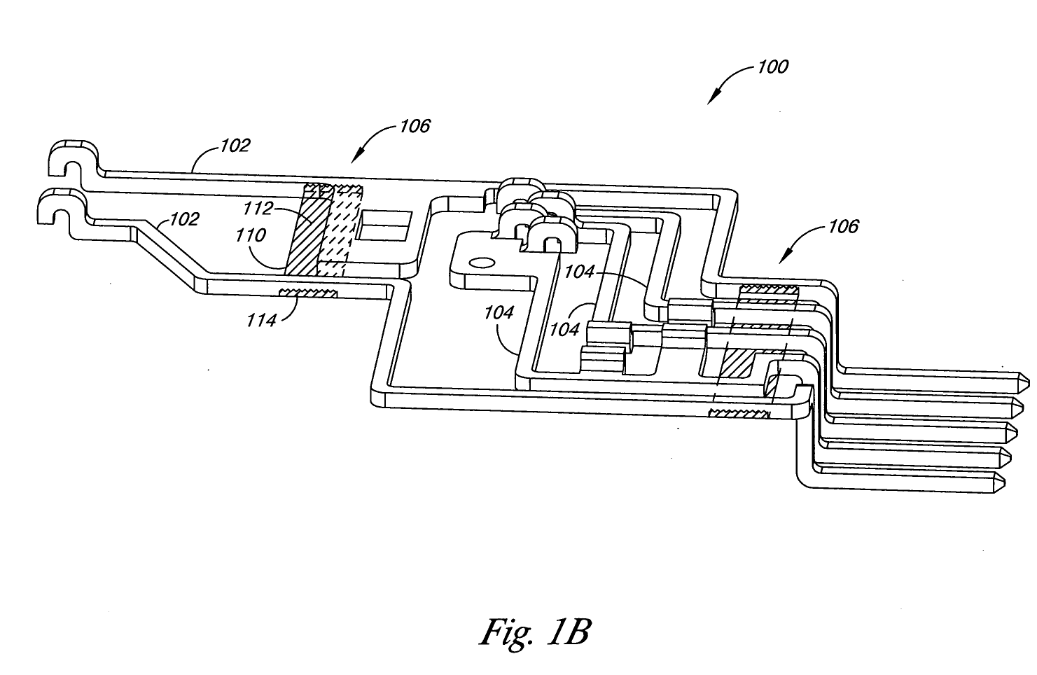

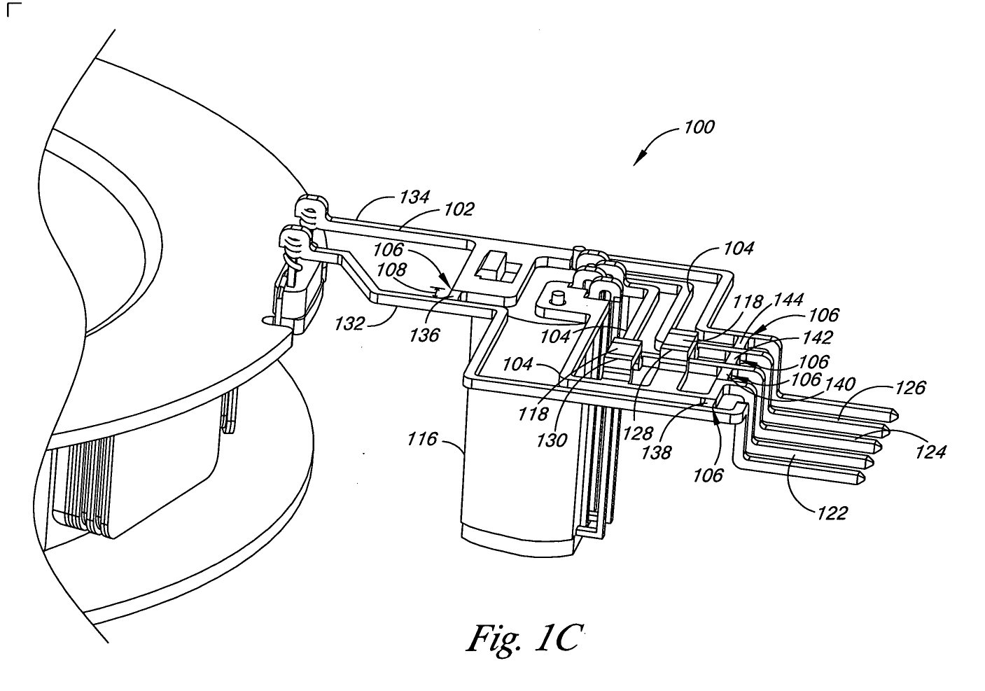

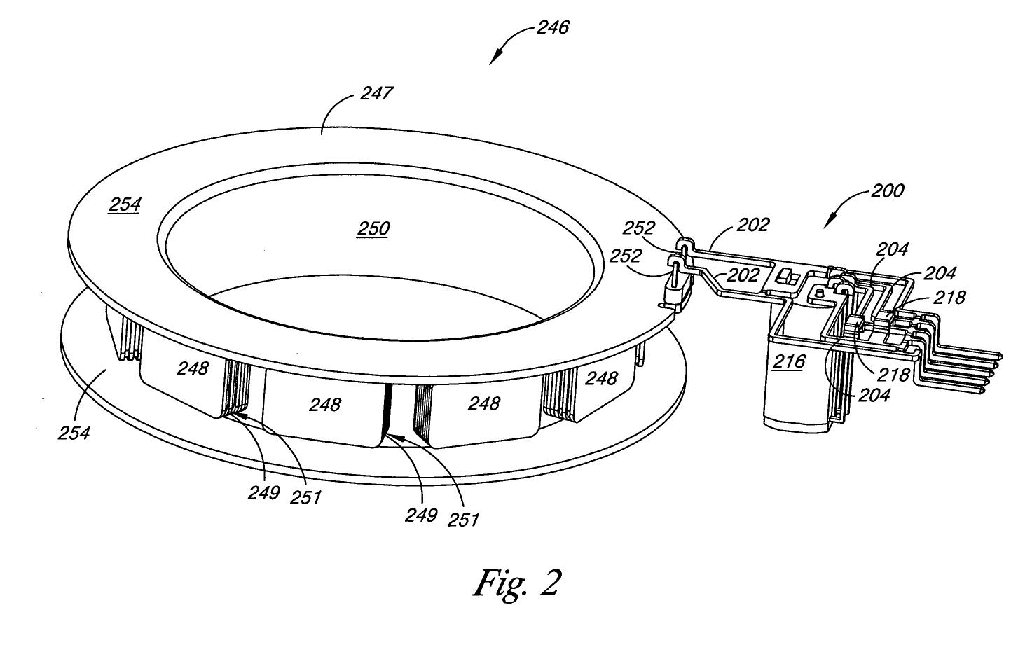

The Figures herein follow a numbering convention in which the first digit or digits correspond to the drawing figure number and the remaining digits identify an element in the drawing. Similar elements between different figures may be identified by the use of similar digits. For example, 102 may reference element “102” in FIG. 1, and a similar element may be referenced as “202” in FIG. 2. As will be appreciated, elements shown in the various embodiments herein can be added, exchanged, and/or eliminated so as to provide a number of additional embodiments. The elements and/or embodiments illustrated in the figures are not to scale.

FIG. 1A provides an illustration of one embodiment of a lead frame 100 according to the present disclosure. The lead frame includes two or more control tracks 102 for connection to a stator winding that carry electric signals for control of a stator, and two or more signal tracks 104 for providing electric signals to a control circuit, as discussed herein.

In some embodiments, the control tracks 102 and signal tracks 104 are formed of an electrically conductive material. For example, the control tracks 102 and signal tracks 104 can be formed of a metal or metal-alloy including copper, gold, silver, aluminum, and/or tin/lead alloys, among others. The control tracks 102 and signal tracks 104 can also be formed of non-metallic materials that are electrically conductive. In some embodiments, the control tracks 102 and signal tracks are formed of the same material. In some embodiments, the control tracks 102 and signal tracks 104 are formed of different materials. The control tracks 102 and signal tracks 104 can then be welded together to form the lead frame 100.

In some embodiments, the lead frame 100 is formed by stamping the control tracks and the signal tracks 102, 104 out of a sheet of material suitable to form the lead frame 100, as discussed herein. The control and signal tracks 102, 104 can then be shaped by bending the tracks 102, 104 into the desired position. In addition, the control and signal tracks 102, 104 can be separated from each other by an electrically-insulative material, as discussed herein.

In some embodiments, the control tracks 102 and signal tracks 104 of the lead frame 100 can be formed of a thin strip or wire of a metal or metal-alloy, as discussed herein, and inserted into a plastic sleeve to hold the control tracks 102 and signal tracks 104 in a desired position. In such embodiments, FIGS. 1A-1C can illustrate the plastic sleeve, where the control tracks 102 and signal tracks 104 are inside the plastic sleeve. The plastic sleeve can be formed of a thermoset material, as discussed herein, or other plastic materials that can withstand the heat generated by the motor and/or the stator coils.

As illustrated in FIG. 1A, the lead frame 100 includes a removable support 106 for maintaining a predetermined distance 108 between the two or more control tracks 102 and the two or more signal tracks 104. The two or more control tracks 102 and the two or more signal tracks 104 are kept a predetermined distance 108 apart to maintain electrical separation.

In some embodiments, the removable support 106 can have a bridge structure formed of the same material as the lead frame control tracks 102 and/or signal tracks 104, where the bridge structure is positioned between the control tracks 102 and signal tracks 104. In this embodiment, once the lead frame 100 is formed, the removable support 106 can be removed to electrically separate the control tracks 102 and the signal tracks 104. For example, the bridge structure can be formed such that the bridge between the tracks 102, 104 can be punched out. Other methods of removing the removable support 106 are also possible.

FIG. 1B illustrates an embodiment of the lead frame 100, where the removable support 106 includes an insulative sheet 110 with a first side 112 and a second side 114, and the first side 112 includes an adhesive for securing the insulative sheet 110 to the lead frame 100. The insulative sheet 110 can be formed of several insulative materials. Examples of suitable insulating material can include, but are not limited to, Kapton® tape, NOMEX, MYLAR, TufQUIN, and the like.

The adhesive can also be either natural based on vegetable, food, and mineral sources, or synthetic such as an elastomer, thermoplastic, or thermosetting adhesive. Since the insulative sheet 110 is formed of an insulative material, the insulative sheet 110 can be placed on the lead frame 100 to hold the control tracks 102 and the signal tracks 104 a predetermined distance apart. In some embodiments, the insulative sheet 110 can remain on the lead frame 100 while the lead frame 100 is encapsulated with an over-molded housing, as discussed herein. Alternatively, the insulative sheet 110 can be removed from the lead frame 100 before the lead frame 100 is encapsulated with an over-molded housing.

FIG. 1C illustrates an embodiment of the lead frame 100, where the lead frame 100 includes a Hall-effect sensor 116 and a capacitor 118. In some embodiments, the Hall-effect sensor 116 can be positioned adjacent to a stator winding 117 fixed to a stator and in close proximity to rotor magnets to enable the Hall-effect sensor 116 to adequately sense a magnetic field by the permanent magnets of the rotor. During this magnetic field sensing operation, the Hall-effect sensor 116 provides electric signals to a control circuit which enables the control circuit to determine the angular position of the rotor within the stator. The control circuit can consequently control the motor commutation process and output currents to a stator coil in a way that controls the position of the rotor relative to the stator. The currents in the stator coil generate a magnetic field, which produces torque by interaction with the permanent magnets on the rotor shaft pushing the rotor to rotate about the rotor shaft to a new position.

As shown in FIG. 1C, the Hall-effect sensor 116 can be coupled to two or more signal tracks 104, and two capacitors 118 can be coupled to the two or more signal tracks 104 to dampen the electric signal provided by the Hall-effect sensor 116. By including the Hall-effect sensor 116 and capacitors 118 on the lead frame 100, and using the lead frame 100 to connect a stator to a control circuit, the present disclosure does not require a printed circuit board (PCB).

In some embodiments, the two or more signal tracks 104 can include a first signal track 122, a second signal track 124, and a third signal track 126. In some embodiments, the Hall-effect sensor 116 can be coupled to the first, second, and third signal tracks 122, 124, 126. In some embodiments, a first capacitor 128 can be coupled to the third signal track 126 and the second signal track 124 and a second capacitor 130 can be coupled to the first signal track 122 and the second signal track 124 at a point distal to the Hall-effect sensor 116. In this embodiment, the first and second capacitors 128, 130 can dampen the electric signals sent by the Hall-effect sensor 116 to a control circuit.

In some embodiments, the two or more control tracks 102, as discussed herein, can include a first control track 132 and a second control track 134. In such embodiments, the removable support 106, as discussed herein, can include a first bridge structure 136 positioned between the first control track 132 and second control track 134 proximal to the Hall-effect sensor 116. As discussed herein, the removable support 106 can also be an insulative fabric with an adhesive backing to keep the first control track 132 and second control track 134 a predetermined distance 108 apart.

In some embodiments, the removable support 106 can also include a second, third, fourth, and fifth bridge structure 138, 140, 142, 144 positioned between the first control track 132, the second control track 134, the first signal track 122, the second signal track 124, and the third signal track 126. Other configurations are also possible depending on the number of control tracks 102 and signal tracks 104 that make up the lead frame 100. As discussed herein, the removable support 106 can also be an insulative fabric with an adhesive backing to keep the first control track 132, the second control track 134, the first signal track 122, the second signal track 124, and the third signal track 126 a predetermined distance 108 apart.

In some embodiments, the first, second, and third signal tracks 122, 124, 126 can be positioned between the first and second control tracks 132, 134. Other configurations are also possible.

FIG. 2 illustrates a stator 246 including a bobbin 247, stator sections 248, stator windings 249, and a lead frame 200 connected to the stator windings 249 according to the present disclosure. As illustrated, the stator 246 includes a number of annularly arranged stator sections 248. The stator sections 248 each include slots 251 that extend longitudinally along the length of the stator section 248. The slots 251 can receive a number of stator windings 249 formed of insulated conductive wire wound within the slots 251. As will be appreciated, stators formed according to the teachings of the present disclosure can include various numbers of stator sections 248 and thus, the embodiment illustrated in FIG. 2 is not meant to limit the present disclosure but rather to show one of many stators that can be formed with the stator section 248.

As the reader will appreciate, the dimensions of the various portions of the stator 246 can be designed to accommodate varying diameters and lengths of insulated conductive wires that form the stator windings 249. In various embodiments, the insulated conductive wire can include various cross-sectional shapes. For example, in some embodiments, the insulated conductive wires can include a round cross-sectional shape, and in other embodiments, the insulated conductive wire can include a planar or rectangular cross-sectional shape (i.e., flat).

The insulated conductive wire can be formed around the stator sections 248 using methods known in the art into the desired stator-winding configuration to form the stator coil. For example, the wires may be shaped to form a complete poly-phase stator winding, or may be shaped to form separate single-phase stator windings, which subsequently may be combined into a multiple phase configuration, if the desired application so requires. In various embodiments, the stator windings 249 can be produced from conductive wire of a desired gauge, the conductive wire comprising a single strand conductive wire pre-coated with insulation.

The stator sections 248 can include a stator core formed, for example, of stacked metal laminations, where a portion of the stator core serves as a magnetic pole for the stator. The stator core can include various types of stacks of metal laminations. For example, in some embodiments, the stacked laminations forming the stator sections 248 can be iron and/or other metal or metal-alloys that can provide a magnetic field (e.g., cobalt, nickel, alloys thereof). As will be appreciated, the stator core can be formed of varying numbers of blocks of stacked laminations of metal (e.g., one block or more).

In addition, in some embodiments, the stator 246 can also include stator winding and locking features, wire guides, sensor board mountings, and wire insulation. Also, in some embodiments, the stator 246 can include terminals 252 for connecting the lead frame 200 to the stator 246. In some embodiments, the lead frame 200 control tracks 202 can be crimped over the terminals 252 and coupled to the terminals 252 using a plasma arc weld. Other methods of coupling the terminals 252 and the control tracks 202 are also possible.

As illustrated, the lead frame 200 can be connected to the stator 246 via the terminals 252 on the top surface of the bobbin 247. In such embodiments, the lead frame 200 extends from the terminals 252 parallel relative the top surface of the bobbin 247. Embodiments of the present disclosure are not limited to lead frames 200 extending from the terminals 252 parallel relative the top surface of the bobbin 247. In some embodiments, the lead frame 200 can extend from the terminals 252 at an acute or obtuse angle relative the top surface of the bobbin 247.

In some embodiments, the terminals 252 can be placed circumferentially around the top surface of the stator 246 to allow the stator windings 249 to be connected to more than one lead frame 200. Alternatively, a circular lead frame 200 can be connected to terminals 252 placed circumferentially around the top surface of the stator. Other configurations for the lead frame 200 are also possible, including a half-circle shape, among others.

In some embodiments, the lead frame 200 can include a Hall-effect sensor 216, as discussed herein. The Hall-effect sensor 216 can be coupled to two or more signal tracks 204 to sense a magnetic field and to provide electric signals to a control circuit via the signal tracks 204. In some embodiments, the lead frame 200 can also include capacitors 218 for dampening the electric signal provided by the Hall-effect sensor 216, as discussed herein.

As discussed herein, the stator 246 can be coupled to the lead frame 200 using the terminals 252, which are in turn, coupled to terminal portions of the stator windings 249. The stator windings 249 are coupled to the lead frame 200 such that the terminals 252, the lead frame 200, and the stator windings 249 form an electrical conduit for conducting electrical potential between the stator 246 and a power source and/or a control circuit. In some embodiments, the lead frame 200 can be connected to the terminals 252 by soldering, welding, or a plug connection.

Methods and processes for forming the various components of the stator described herein are provided as non-limiting examples of the present disclosure. As will be appreciated, a variety of molding processes exist that can be used to form the stator components. Examples of such molding processes can include resin transfer molding, compression molding, transfer molding, and injection molding, among others.

Embodiments of the stator 246 components can also be formed from a number of different materials. For example, the bobbin 247 can be formed of, by way of illustration and not by limitation, thermoplastic and thermoset polymers. As used herein, a thermoset polymer includes those polymeric materials that once shaped by heat and pressure so as to form a cross-linked polymeric matrix are incapable of being reprocessed by further application of heat and pressure. As provided herein, thermoset materials can be formed from the polymerization and cross-linking of a thermoset precursor. Such thermoset precursors can include one or more liquid resin thermoset precursors. In one embodiment, liquid resin thermoset precursors include those resins in an A-stage of cure. Characteristics of resins in an A-stage of cure include those having a viscosity of 1,000 to 500,000 centipoises measured at 77° F. (Handbook of Plastics and Elastomers, Editor Charles A. Harper, 1975).

In the embodiments described herein, the liquid resin thermoset precursor can be selected from an unsaturated polyester, a polyurethane, an epoxy, an epoxy vinyl ester, a phenolic, a silicone, an alkyd, an allylic, a vinyl ester, a furan, a polyimide, a cyanate ester, a bismaleimide, a polybutadiene, and a polyetheramide. As will be appreciated, the thermoset precursor can be formed into the thermoset material by a polymerization reaction initiated by heat, pressure, catalysts, and/or ultraviolet light.

As will be appreciated, the thermoset material used in the embodiments of the present disclosure can include non-electrically conducting reinforcement materials and/or additives such as non-electrically conductive fillers, fibers, curing agents, inhibitors, catalysts, and toughening agents (e.g., elastomers), among others, to achieve a desirable combination of physical, mechanical, and/or thermal properties.

Non-electrically conductive reinforcement materials can include woven and/or nonwoven fibrous materials, particulate materials, and high strength dielectric materials. Examples of non-electrically conductive reinforcement materials can include, but are not limited to, glass fibers, including glass fiber variants, synthetic fibers, natural fibers, and ceramic fibers.

Non-electrically conductive fillers include materials added to the matrix of the thermoset material to alter its physical, mechanical, thermal, or electrical properties. Such fillers can include, but are not limited to, non-electrically conductive organic and inorganic materials, clays, silicates, mica, talcs, asbestos, rubbers, fines, and paper, among others.

In an additional embodiment, the liquid resin thermoset precursor can include a polymerizable material sold under the trade designator “Luxolene” from the Kurz-Kasch Company of Dayton, Ohio.

Examples of thermoplastic polymers include polyolefins such as polyethylene and polypropylene, polyesters such as Dacron, polyethylene terephthalate and polybutylene terephthalate, vinyl halide polymers such as polyvinyl chloride (PVC), polyvinylacetate such as ethyl vinyl acetate (EVA), polyurethanes, polymethylmethacrylate, pellethane, polyamides such as nylon 4, nylon 6, nylon 66, nylon 610, nylon 11, nylon 12 and polycaprolactam, polyaramids (e.g., KEVLAR), segmented poly(carbonate-urethane), Rayon, fluoropolymers such as polytetrafluoroethylene (PTFE or TFE) or expanded polytetrafluoroethylene (ePTFE), ethylene-chlorofluoroethylene (ECTFE), fluorinated ethylene propylene (FEP), polychlorotrifluoroethylene (PCTFE), polyvinylfluoride (PVF), or polyvinylidenefluoride (PVDF).

In one embodiment, the bobbin 247 can be formed through an injection molding process. For example, a single mold can be configured to provide for the shape of the bobbin 247. The thermoplastic material, or thermoset material, can be injected into the mold to form the bobbin 247. In alternative embodiment, the bobbin 247 could be formed in a casting process or stamping. In alternative embodiment, segments of the bobbin 247 can be individually formed and then coupled together to form the bobbin 247. For example, one or more of the circular surfaces 254 can be individually formed. The individual segments can then be coupled together to form the bobbin 247 as illustrated in FIG. 2. Examples of suitable techniques for coupling the individual segments include use of chemical adhesives and/or thermal energy to weld the individual segments together.

Similarly, the stator sections 248 can be individually formed from a thermoset material, as discussed herein, and positioned in the bobbin 247 after the stator windings 249 have been wound around the stator sections 248. The stator sections 248 can then be secured into the appropriate configuration using, for example, an adhesive. Alternatively, the bobbin 247 can be formed with the stator sections 248 as a single part. In this embodiment, the stator windings 249 can be wound around the stator sections 248 after the bobbin 247 has been formed.

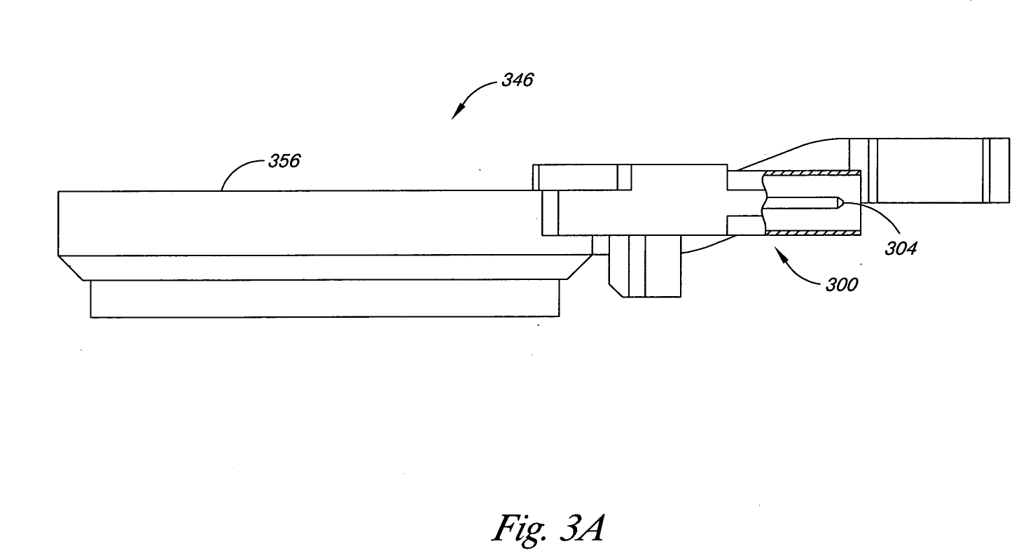

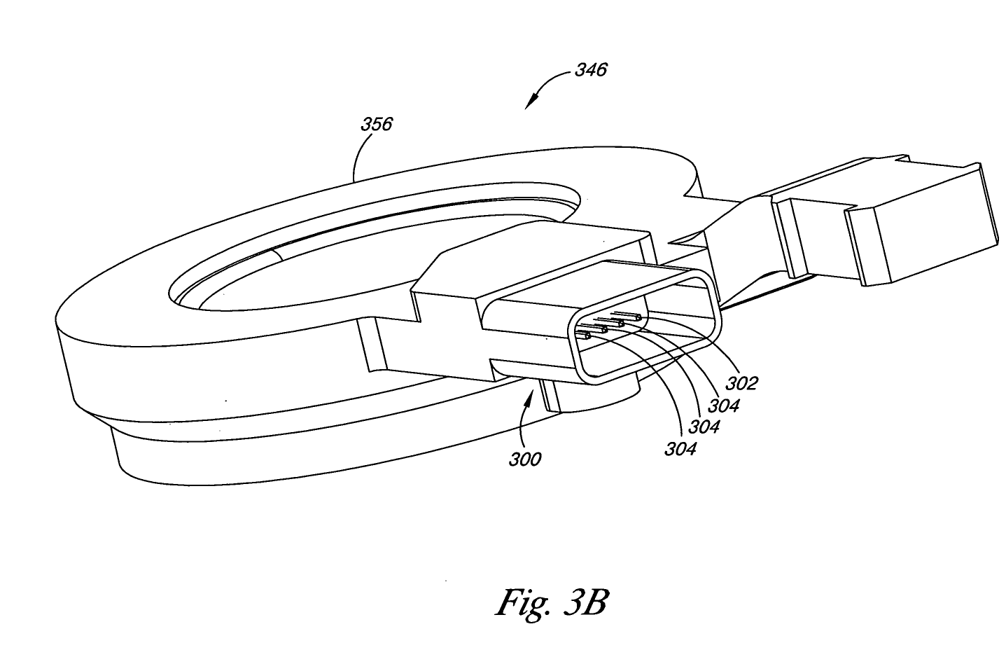

FIGS. 3A and 3B illustrate an over-molded housing 356 encasing the stator 346 and the lead frame 300. The over-molded housing 356 can restrain the internal components of the lead frame 300 and stator 346 to permit the internal components to withstand a higher vibration and shock load than the internal components could withstand without the over-molded housing 356. Therefore, by providing an over-molded housing 356, the displacement of unrestrained internal components can be prevented, which can cause high point stresses and premature failure.

As illustrated, the housing 356 encases at least a portion of the stator 346. In addition, FIGS. 3A and 3B illustrate the stator 346 completely encased. As illustrated in FIG. 3B, the stator 346 and lead frame 300 can be completely encased by the over-molded housing 356, but have electrical tracks 302, 304 extending from the housing 356. FIG. 3B also illustrates how the over-molded housing 356 can extend between the two or more electrically conductive tracks, such as the control tracks 302 and the signal tracks 304.

In some embodiments, the over-molded housing 356 can be formed of a material that has characteristics determined by the designer based on environmental, mechanical, and thermal stresses that will be applied to the stator 346 and lead frame 300. For example, in some embodiments, the over-molded housing 356 can be formed of a material with a sufficiently high thermal conductivity to conduct heat away from the stator 346 and the lead frame 300 to operate the stator 346 and the lead frame 300, including other components on the lead frame 300, as discussed herein. A higher thermal conductivity can permit heat rise in the stator windings to be minimized and thus keep stator winding resistance down and the stator winding power up. In addition, the currents through the stator windings generate heat which can have a detrimental affect on the Hall-effect sensor. In particular, many Hall-effect sensors have a maximum operating temperature which is less than one hundred fifty (150) degrees Celsius.

In some embodiments, the material for the over-molded housing 356 can be chosen based on mechanical and environmental stresses on the stator 346 and lead frame 300. For example, an over-molded housing 356 formed of Nylon 6/6 can provide for mechanical strength by restraining the stator winding in the assembly and environmental strength by protecting the stator winding from external contamination.

In an alternative embodiment, the stator 346 can be over-molded with a thermoset material, as discussed herein. As will be appreciated, the stator 348 can be placed within a molding tool and the thermoset material can be supplied to the molding tool to encapsulate the stator 348. In one embodiment, the thermoset material can be supplied to the molding tool to completely encapsulate the stator 348 and the lead frame 300.

Providing the thermoset material can include injecting a thermoset precursor (e.g., low-viscosity thermoset precursor) and catalyst (optional) into the molding under low pressure to fill the mold cavity volume such that the thermoset material encapsulates the stator 348 and the lead frame 300, except the signal and control tracks 302, 304, which extend therefrom. Since the thermoset precursor can include a low viscosity, the thermoset precursor can substantially fill spaces defined by various surfaces of the stator 348 and the lead frame 300, such as spaces between and around the signal and control tracks 304, 302, spaces within slots and grooves, and spaces between stator sections, the stator windings of the stator 346, among other spaces. Heat and pressure can then be applied to cure the thermoset precursor to form the over-molded housing 356. A post cure process can also be used. After curing, the over-molded housing 356 encasing the stator 348 and lead frame 300 can be removed from a molding tool.

Encapsulating (e.g., completely encapsulating) the stator 346 within a thermoset material can provide for improved heat transfer characteristics there from. For example, the thermoset material encasing the stator windings serves to efficiently conduct heat away from the windings and also to fill the gaps between the windings. In addition, the various portions of the stator 346 can be tightly secured together by complete encapsulation. For example, the capsule serves to secure the stator windings to the stator sections 248 to prevent movement of the windings. The thermoset material also serves to secure the stator sections to each other to help prevent the movement of the stator sections with respect to each other.

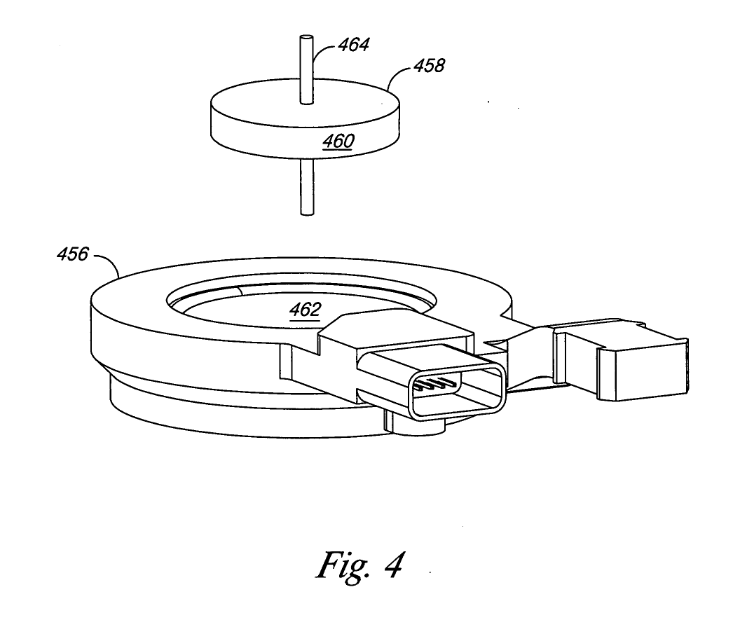

FIG. 4 illustrates an exploded view of an embodiment of an electric motor including an over-molded housing 456 encasing a stator and a lead frame, and a rotor 458 for use in an electrical motor according to the present disclosure.

As will be appreciated, embodiments of the stator 446 and the rotor 458 of the present disclosure can be utilized in a variety of motor configurations. For example, suitable motor configurations can include motors that operate on alternating current (AC) (i.e., induction or synchronous AC motor, switched reluctance motor) and/or direct current (DC) (e.g., a universal motor or a DC motor). As understood, AC motors can be configured as a single-phase, split-phase, poly-phase, or a three-phase motor. Furthermore, it will be apparent to those skilled in the art from this disclosure that although embodiments of the present disclosure are used with an electric motor, the embodiments can also be used with other rotary type electric machines such as a generator or motor/generator.

As illustrated in FIG. 4, in some embodiments, the over-molded housing 456 encasing the stator can circumferentially surround the rotor 458. The rotor 458 can be positioned inside the over-molded housing 456 encasing the stator in such a way that when the rotor 458 rotates, an outer surface 460 of the rotor 458 is proximate to, but does not touch, an inner surface 462 of the over-molded housing 456 encasing the stator.

As will be appreciated, the rotor 458 can be housed at least partially within and rotate relative the stator about a rotational shaft 464 supported by structures that include bearings. As discussed herein, the stator can include a stator section including a stator core and a number of stator windings formed of insulated conductive wire wound around the stator section. The stator windings can generate a magnetic field for driving the rotor 458.

In some embodiments, the over-molded housing 456 can encase both the stator and the lead frame, as discussed herein. The lead frame can be connected to the stator windings and can include two or more electrically conductive tracks for transmitting electric signals from and/or to the stator windings. As discussed herein, the over-molded housing 456 can extend between the two or more electrically conductive tracks of the lead frame.

While the present disclosure has been shown and described in detail above, it will be clear to the person skilled in the art that changes and modifications may be made without departing from the spirit and scope of the disclosure. As such, that which is set forth in the foregoing description and accompanying drawings is offered by way of illustration only and not as a limitation. The actual scope of the disclosure is intended to be defined by the following claims, along with the full range of equivalents to which such claims are entitled.

In addition, one of ordinary skill in the art will appreciate upon reading and understanding this disclosure that other variations for the disclosure described herein can be included within the scope of the present disclosure.

1. A lead frame for a stator, comprising:
two or more control tracks for connection to a stator winding;
a Hall-effect sensor coupled to two or more signal tracks for sensing a magnetic field and for providing electric signals to a control circuit
a capacitor coupled to the two or more signal tracks for dampening the electric signal provided by the Hall-effect sensor; and
a removable support for maintaining a predetermined distance between the two or more control tracks and the two or more signal tracks.

2. The lead frame of claim 1, where the predetermined distance between the two or more control tracks and the two or more signal tracks is for maintaining electrical separation of the two or more control tracks and the two or more signal tracks.

3. The lead frame of claim 1, where the support includes an insulative sheet with a first side and a second side, where the first side includes an adhesive for securing the insulative sheet to the lead frame.

4. The lead frame of claim 1, where the support includes a bridge structure positioned between the two or more control tracks and the two or more signal tracks, where the bridge structure and the tracks are formed of a same material.

5. The lead frame of claim 1, where the two or more signal tracks include a first signal track, a second signal track, and a third signal track and the Hall-effect sensor is coupled to the first signal track, second signal track, and third signal track.

6. The lead frame of claim 5, where a first capacitor is coupled to the third signal track and the second signal track and positioned distal to the Hall-effect sensor.

7. The lead frame of claim 5, where a second capacitor is coupled to the first signal track and the second signal track and is positioned distal to the Hall-effect sensor.

8. The lead frame of claim 5, where the two or more control tracks include a first control track and a second control track, and the removable support includes a first bridge structure positioned between the first control track and the second control tack positioned proximal to the Hall-effect sensor, where the first and second control track are formed of a same material as the bridge structure.

9. The lead frame of claim 8, where the removable support further includes a second, third, fourth, and fifth bridge structure positioned between the first control track, the second control track, the first signal track, the second signal track, and the third signal track.

10. The lead frame of claim 9, where the first, second, and third signal tracks are positioned between the first and second control tracks.

11. A stator, comprising:
a stator winding;
a lead frame connected to the stator winding, where the lead frame includes two or more electrically conductive tracks to carry electric signals for control of the stator; and
an over-molded housing encasing the stator and the lead frame.

12. The stator of claim 11, where the lead frame includes a Hall-effect sensor coupled to two or more signal tracks for sensing a magnetic field and for providing electric signals to a control circuit.

13. The stator of claim 12, where the lead frame includes a capacitor coupled to the two or more signal tracks for dampening the electric signal provided by the Hall-effect sensor.

14. The stator of claim 11, where the over-molded housing extends between the two or more electrically conductive tracks.

15. An electric motor comprising:
a stator;
a rotor that rotates relative the stator;
a stator winding wound on the stator for generating a magnetic field for driving the rotor;
a lead frame connected to the stator winding, where the lead frame includes two or more electrically conductive tracks; and
an over-molded housing encasing the stator and the lead frame, where the housing extends between the two or more electrically conductive tracks.

16. The electric motor of claim 15, where a portion of the two or more electrically conductive tracks extend from the over-molded housing.

17. The electric motor of claim 15, where the lead frame includes a removable support for maintaining a predetermined distance between the two or more electrically conductive tracks.

18. The electric motor of claim 17, where the removable support includes a bridge structure positioned between the two or more electrically conductive tracks, where the bridge structure and the electrically conductive tracks are formed of a same material.

19. A method of manufacture, comprising:
forming a stator section including a stator core;
forming a stator winding, where the stator winding is wound around the stator section;
forming a lead frame including:
two or more control tracks;
two or more signal tracks; and
a removable support positioned between the two or more control tracks and the two or more signal tracks;
coupling the two or more control tracks to the stator winding;
coupling a Hall effect sensor and a capacitor to the two or more signal tracks; and
over-molding the stator section, stator winding, and lead frame.

20. The method of claim 19, where forming the lead frame including the removable support includes forming a bridge structure of a same material as the two or more control tracks.

21. The method of claim 20, where forming a lead frame further includes removing the bridge structure to electrically isolate the two or more control tracks and the two or more signal tracks.

22. The method of claim 19, where forming the lead frame including the removable support includes placing an insulative sheet with a first side and a second side, where the first side includes an adhesive on the lead frame to maintain a predetermined distance between the two or more control tracks and the two or more signal tracks.

23. The method of claim 19, where over-molding the stator section, stator winding, and lead frame includes over-molding the lead frame such that over-molding extends between the two or more control tracks and the two or more signal tracks.
